(19) United States
(12) Patent Application Publication
(10) Pub. No.: US 2004/0093231 A1
(43) Pub. Date: May 13, 2004

(54) Charitable organization funding and member benefit program

(76) Inventor: Donald L. Walz, Las Vegas, NV (US)

Correspondence Address: M. REID RUSSELL, 854 WEST 3390 SOUTH, HURRICANE, UT, 84737, US

(21) Appl. No.: 10/677,936

(22) Filed: Oct. 2, 2003

Related U.S. Application Data
(63) Continuation-in-part of application No. 09/642,599, filed on Aug. 22, 2000, now abandoned.

(51) Int. Cl. G06F 17/60

(52) U.S. Cl. 705/1

(57) ABSTRACT

A charitable organization funding and member benefit program to include an organization that receives donations that are tax deductible from members who commit to, payment of dues, regular donations of blood and may agree to the performance of services and donation of their usable organs at their death, to the organization. The member donation to provide the organization an insurable interest in each member that can be funded from the member dues and donations, which insurance proceeds can fund a burial plan for each member who meets their agreement to the organization during their life, with the organization to provide funeral and burial or cremation services to the member commensurate with the members actual contributions. The organization uses a computer to both maintain a running account of the members contribution and to maintain personal information about each member for aiding in blood and organ matching and for, as needed, locating and identifying members at the request of family or authorities.

This application is a continuation-in-part application of an application Ser. No. 09/642,599 for a “CHARITABLE ORGANIZATION FUNDING AND MEMBER BENEFIT SYSTEM” filed Aug. 22, 2000 that is abandoned with the filing of this CIP application.

### BACKGROUND OF THE INVENTION

1. Field of the Invention

This invention generally relates to a funding and benefit plan that will provide benefits to individuals for their commitment to, and support of, an organization that, in turn, benefits from the support of such individuals, with the individual supporting the organization with their donations of money, time, blood and services as well as their bequeathing their usable organs at their deaths for the benefit of the organization, and with the organization providing valuable services to the individual during their life and funeral and burial or cremation benefits at their death.

2. Description

The invention is in a program to include an entity that has a tax exempt status, such as a non-profit corporation having an organizational structure that is geared to providing, on a need basis, a variety of services to the public. An example of such an organization is the American Red Cross that is well known and respected for providing disaster relief services and further has in place a system for collecting and distributing blood products across the country, providing safe and pure blood products to persons having a need to supplement their blood supply. The Red Cross, or like organization, can extend their activities to organ transfers, and could acquire commitments from cemeteries and mortuaries to handle their members internments, or could themselves acquire, through purchase or gift, such cemeteries and mortuaries to directly provide burial services to members. As additional member benefits for committing money, through membership fees and donations, periodic blood donations, and donation of their usable organs at their death, the member, in life, would receive, from companies that are friends of the organization, group benefits and incentives as well as discounts for: purchases; loans; banking; insurance, and the like, and can be provided with other services such as legal and medical, within the scope of the services offered by the organization to its loyal members. Further, the member, through their Social Security Number, DNA, and/or the like, can be quickly identified at death providing for a quick process of their death benefits, if any. With, at death, the loyal member is vested with a funeral and burial or cremation package, that may be like a pre-paid funeral plan, as compensation for their actual donations as tracked by the organization during their life. Accordingly, during a members life the organization benefits from the members efforts, donations, and commitments, and the member, during their life, receives membership benefits and assistance as they need, and, at their death, their funeral and internment or cremation is handled by the organization in coordination, as appropriate, with relatives of the deceased.

3. Prior Art

Heretofore publically funded organizations, such as the American Red Cross, have solicited and received support from individual members, with such members deriving benefits such as the satisfaction they receive from doing their part for such well known and respected organization and, in some cases members have received discounts on their purchases of product and services from friends of the organization. Heretofore, however, no organization has undertaken obligations to individual members as the present plan contemplates. Applicant therefore believes the plan of the present invention is both novel and unique as a first of its kind.

### SUMMARY OF THE INVENTION

It is a principal object of the present invention to provide a program involving a charitable organization and its members where, for members who support the organization through their donations and commitments during their life, the organization will assist its individual members during their life and will provide for their funeral and burial or cremation at their death.

Another object of the present invention is to provide a program that includes a charitable organization, that is preferably tax exempt, where members donations will be tax deductible, with the members who commit to payments of annual dues or fees, periodically donate blood, and agree to and do support the organization during their life, receive both benefits and assistance during their life and are given a funeral and burial or cremation by the organization at their death.

Another object of the present invention is to provide a program where the organization, for their member's commitments to the organization, provide benefits to individual members in the form of incentives, such as discounts for products and services, services such as legal assistance in estate planning and/or the like, limited medical assistance, and other benefits during the members life.

Another object of the present invention is to provide a system where, for a member who has fulfilled their commitments to the organization, for example, timely payment or periodic dues, or the like, who has met their quota of blood donations, or the like, and may have committed their usable organs to the organization at their death, that member will be afforded a funeral with burial or cremation similar to a prepaid burial plan whose value is, at least in part, attributable to the value of their donations as established by and tracked by the organization during their life.

Still another object of the present invention is to provide a program where the organization, to fund its obligations, will have an insurable interest in its individual members, with the payment for such insurance paid from the members dues and contributions, and with the proceeds from such insurance to pay for the members funeral and burial or cremation expenses at the members death and to additionally provide for financing the organization.

Still another object of the present invention is to provide a program where information concerning individual members, such as their social security number, finger prints, DNA information, and the like, can be maintained by the organization to assist in matching their blood and organs to others, can be included, with a record kept by the organization to establish a value of the burial plan provided to the member at their death, and which information can be selectively made available to local authorities, on legitimate request, to facilitate identifying a member or their remains.

Still another object or the invention is to provide a program that is structured to help its individual members during their life and provide for their funeral and burial or cremation at their death, and with the members paying regular dues, giving blood, and agreeing to donate their organs upon their death, to both sustain the organization and provide for its growth so as to enable it to meet its obligations to its members and to maintain its charitable works for the benefit of humanity.

Based upon the above set out objects, the invention is in a program that is a charitable organization, preferably one that is non-profit and qualifies as being tax exempt, and with donations from members being tax deductible. The organization solicits members with promises of discounts on products and services, professional services, particularly in the area of estate planning and health maintenance, and provides a program for handling the members funeral, including burial or cremation in either a cemetery the organization owns or through contracts with cemeteries, and in coordination with the members family, if any. For which promises the member pledges to periodically pay set amounts of money as dues, agrees to donate blood on a regular basis to the organization or to the designee of the organization, and may agree to donate their usable organs to the organization, or to an entity designated by the organization, at the members death, with the organization to track the donations and credit them, along with the organ donation, towards a funeral plan having a value commensurate with the value of the donations. The organization to pay the cost the funeral plan to have an insurable interest in the member whereby an insurance policy is taken out on the member at their joining with payments made for which insurance made from the members dues to provide, at the members death, at least an amount sufficient to pay for the earned death benefits, with additional monies to go to the organization. In addition to which death benefits the members blood donations and organs, as are harvested at their death, produce, through the organizations distribution network, operating capital to the organization that enables it, should it elect, to purchase or contract with existing cemeteries and mortuaries so as to provide the members death benefits as well to produce a cash flow to the organization to enable it to continue and expand its services to the public generally. Additionally, inherent in the system, the members personal information, such as their social security number, blood type and even DNA can be maintained by the organization to provide for an efficient distribution of blood and organs to recipients and as necessary, for member identification in cooperation with local authorities, without breaching the members expectation of privacy of their records that the organization holds. Further, the large body of members provides a client base for companies who wish to sell their products or services to members and, accordingly, such companies will provide members discounts to make such sales and will pay the organization for the right to mail to which members seeking their patronage, to both the benefit of the individual members and the organizations.

### THE DRAWINGS

The appended drawing contains a figure showing a block flow of a preferred embodiment of the present invention in a charitable organization funding and benefit program, showing the aspects and features thereof as will be described in connection therewith. The illustrated embodiment, however, it should be understood, is intended only to illustrate the invention. The drawing contains the following figure:

FIG. 1 shows a block flow schematic of the charitable organization funding and benefit system and its interaction with its members, illustrating the invention; and

FIG. 2 shows an exemplary computer system that is suitable for operation by the charitable organization to keep records of the members donation and personal information.

### DETAILED DESCRIPTION

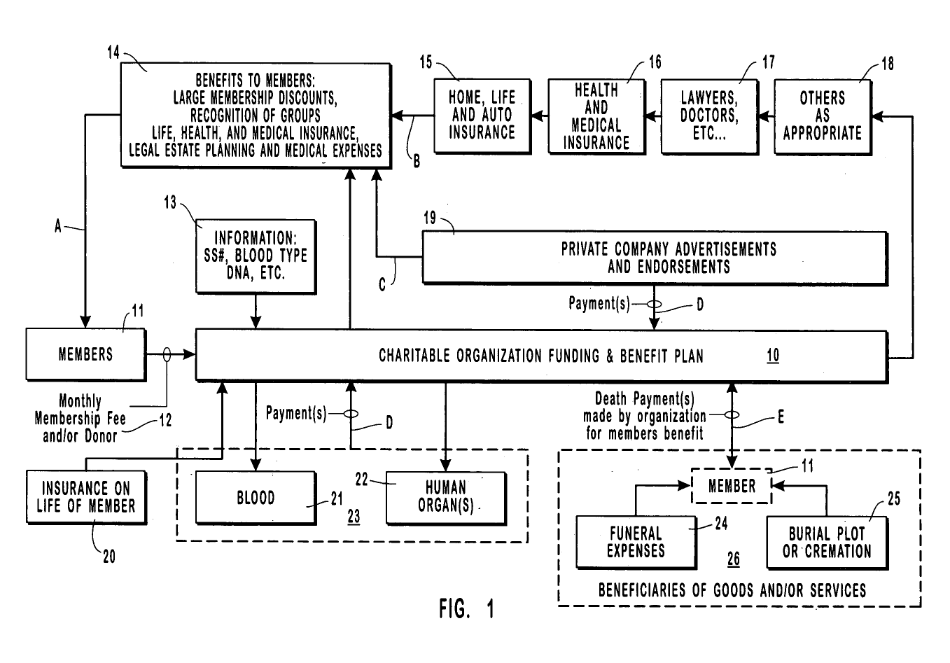

The present invention is generally directed towards a charitable organization funding and benefit program that is preferably practiced by a charitable organization having a tax exempt status where donations to the organization will qualify as tax deductions for organization members. FIG. 1 is a block flow schematic of the charitable organization funding and benefit program of the invention that shows a charitable organization 10, that is preferably a non-profit entity that is world-wide in its activities, such as the American Red Cross, or, of course, can be another entity having a history of aid and service to the public generally in time of emergency or crisis. Though, it should be understood, the invention can be practiced with any organization, even one that is recently organized, within the scope of this disclosure. For an existing organization, such as the American Red Cross, such organization already has in place a national network of blood banks and a blood network distribution system and, accordingly, such organization is well suited to practice the invention, though, as set out above, the invention could be practiced with another organization that has or creates a network as contemplated by the invention.

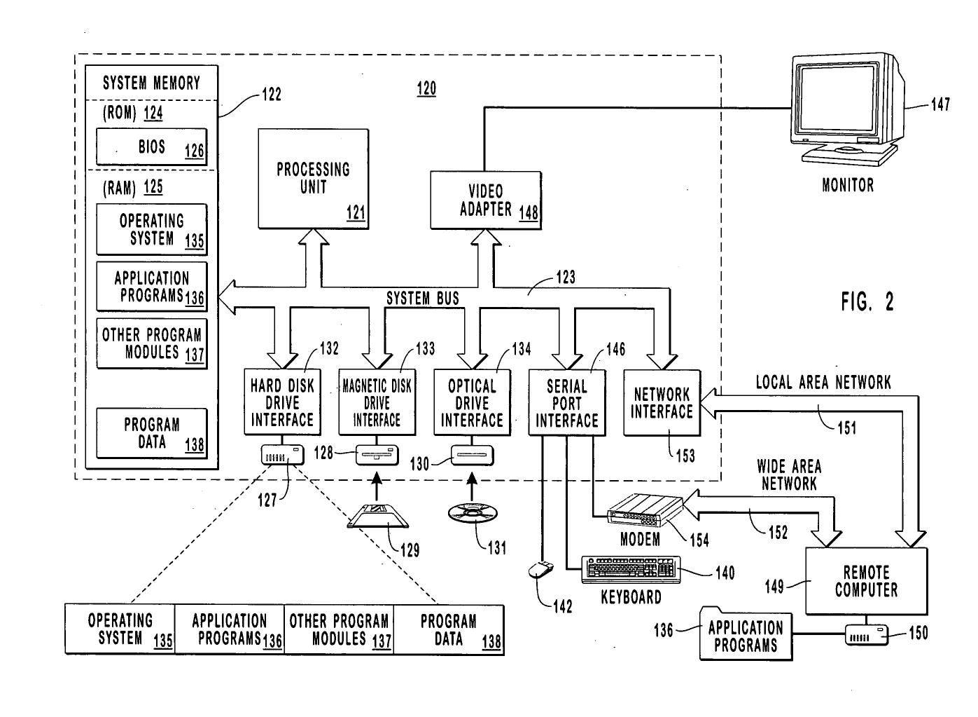

An existing organization will, of course, have a membership that is already in place whose duties and obligations can be expanded, with the organization extending to such members the additional benefits as the plan envisions. Accordingly, members, as shown in block 11, it should be understood, are both present organization members who agree to the new terms and conditions imposed by the system of the invention and additional members as the organization solicits. For the individual member to participate in the system of the invention, each member must agree to pay monthly or other periodic membership fees and agree to donate a determined number of pints of blood over a set time period and may, but preferably shall, donate, at their deaths, their usable organs to the organization or to an entity as the organization conveys these rights to, as illustrated at arrow 12. As part of the membership agreement, the member supplies their vital statistics to the organization, shown at block 13, to include, for example, their social security number, blood type, DNA information, and other information as the organization needs, for example, to facilitate blood and organ matching. Which information is kept in a computer system of the organization as illustrated by the computer system of FIG. 2, and with that information maintained as strictly confidential for identification purposes, except such information could, on a limited basis, be made available to local authorities on a need basis.

The member 11, for their support of the organization, will receive from the organization benefits, as indicated by arrow A flowing from block 14 setting out member benefits, that include, but are not limited to, membership discounts on products, with these and services, shown as flowing to the block identified as members benefits by arrows B, which services are shown as: home, life and auto insurance, block 15; health and medical insurance, block 16, legal services particularly in the estate planning area, medical, particularly health maintenance services, and the like, block 17, and other services as needed, block 18, that, for example, could be other services as would benefit members.

As further member benefits, private companies, as shown in block 19, can provide discounts and purchase incentives to members, illustrated by arrow C, with such private companies paying the organization, indicated by payment arrow D, for providing, with the knowledge and/or approval of the members, lists of their members to such private companies, providing a revenue source to the organization. A further revenue source for the organization is a purchase of insurance on the life of each member, illustrated as block 20. This is possible as each member will have committed to periodic donations of blood to the organization during their life and, accordingly, each member is a key man to the organization whose loss would effect profits of the organization and therefore the organization has an insurable interest in the life of each member.

The organization provides a service to the public by its distribution system for handling blood products, shown at block 21, and human organs, block 22, through its own facilities or by contract with others, shown as broken line block 23. Which operations are to provide a profit to the organization, as illustrated by arrow D. For a member 11, shown in broken line box within broken line box 26, who meets the terms and conditions of their membership to include payment of the prescribed dues, blood donations, and the commitment of their usable organs to the organization at their death, the organization will provide for the funeral and internment or cremation of their remains, per the members wish. To such paid up members the organization provides a burial package takes into account the actual member contribution in determining the value of the burial plan that would be like burial plans as are currently commonly sold by mortuaries, cemeteries and the like, where a set value for a funeral service, coffin and internment or cremation is provided. Should, of course, the members family wish a more expensive funeral package, such could be negotiated for, with the member at least assured of a proper and dignified handling of their last remains. The member funeral expenses and burial plot or cremation are shown as blocks 24 and 25, respectively, with the arrow E emanating from broken line box 26 that contains blocks 24 and 25, respectively, representing an financial outgo by the organization to meet its member obligations. In practice, the insurance the organization maintains on the lives of each of its active members should be more than sufficient to pay the funeral and burial or cremation expenses, with a balance after payment for which services kept by the organization for the purchase of cemeteries, mortuaries, or the like, as they determine, to enable them to economically meet their obligations to their members, or other uses as the organization determines. Additionally, the organization will preferably be empowered by each individual member to represent the members interests regarding funeral expenses as may be due them from the government, as from the Social Security Administration, Veterans Administration, or the like, collecting the benefits that the member is entitled to, with, it is intended, any proceeds from such government agencies going to the organization against their costs for handling the members remains. Thereby, the member, in life, can determine and designate their funeral and internment or cremation wishes and these wishes become the commitment of the organization to the extent of the members actual contributions, with the member meeting their obligations to the organization, relieving the members family from the responsibilities and costs of the members funeral and internment or cremation.

The organization, to maintain member information and for accounting of member vital statistics and contribution maintains that information in a computer arrangement, and one such computer arrangement 120 is shown in FIG. 2. The computer arrangement 120 preferably includes a central processing unit (CPU)121, a memory or storage device 122 and a system bus 123 that couples various system components, such as the memory of storage device 122 and the CPU 121. The system memory or storage device 122 may also include, for example, read only memory ROM)124 and random access memory (RAM)125. The system bus 123 may be any of several type of bus structures including a memory bus or memory controller, a peripheral bus, or a local bus using any of a variety of bus architectures. A basic input/output system (BIOS)126, containing the basic routines that help transfer information between the various elements within the computer 120, such as during start-up, may be stored in the ROM 124.

The computer 120 may also include a magnetic hard disk drive interface 132 operating a magnetic hard disk drive 127 for reading from and writing to a magnetic hard disk (not shown), a magnetic disk drive interface 133 operating a magnetic disk drive 128 for reading from or writing to a removable magnetic disk 129, and an optical disk drive interface 134 operating an optical disk drive 130 for reading from or writing to a removable optical disk 131 such as a CC-ROM or other optical media. The magnetic hard disk drive 127, magnetic disk drive 128, and optical disk drive 134 are connected to the system bus 123 by the hard disk drive interface 132, the magnetic disk drive-interface 133, and optical disk drive interface 134, respectively. These drives and associated computer readable media provide storage for various executable instructions, data structures, program modules and other date for the computer 120, with programs identified as operating system 135, application programs 136, other program modules 137 and program data 138 show as included in the magnetic hard disk of the magnetic hard disk drive 127. It should, however, be understood that while the exemplary computer 120 includes magnetic hard disk (not shown), a removable disk 129 and a removable optical disks 131, other types of computer readable media for storing data can be used to include magnetic cassettes, flash cards, digital video disks, RAM, ROM and the like, for providing computer instructions.

The computer 120 further includes an operating system 135 and one or more application programs 136, other program modules 137, or other program data 138 that may be stored, as for example, on hard disk drive interface 132, magnetic disk drive interface 133, optical disk drive interface 134, ROM 124 or RAM 125. Also, a user may enter commands and input information into the computer 120 through input devices such as a keyboard 140, a pointing device such as a mouse 142, or other suitable device. These input devices are often connected to the processing unit 121 through a serial port interface 146 that is coupled to system bus 123. Alternatively, the input devices may be connected by other interfaces, such as a parallel port, a game port or a universal serial bus (USB). A monitor 147 or another display device is also connected to the system bus 123 via an interface, such as a video adapter 148. Accordingly, one skilled in the art will recognize that the computer 120 may include other output devices such as printers, speakers, and the like, within the scope of this disclosure.

For practicing the invention, and the computer 120 may be connected to a computer network through a network interface of adapter 153 to receive data from a local area network, if such is used to transfer information from offices of the organization, and arrow 151, shows information directed from a remote computer 149, linking computers maintained by the organization, and includes a web browser (not shown) connected therein. For internet or computer to computer; communications, the computer 120 preferably includes a modem 154, which may be internal or external to the computer 120, and is connected to the system bus 128 via the serial port interface 146 to receive data from a wide area network, arrow 152, transmitted to and processed through the web browser and from remote computer 149. With such remote computer also including a magnetic hard disk drive 150 for reading or writing to a magnetic hard disk (not shown) containing application programs 136. While preferably so arranged, it should be obvious to one skilled in the art that the network connections as shown in the accompanying FIG. 2 is exemplary and that other arrangements for establishing communications between computers may be used within the scope of this disclosure.

Operation of the program of the invention provides each member with the personal satisfaction of being part of an organization that is well known for its beneficial efforts for humanity, “helping people” in time of tragedy, war, and natural disaster. Their membership makes them part of a world wide pool of people dedicated to similar goals and interests and provides the member with recognition by other charitable groups. The members contributions are tax deductible and provide them satisfaction in that they know and approve of the works of the organization they are supporting. They know that their contributions in money and blood donations, and the dedication of their usable organs at their death, go to supporting an organization that is dedicated to helping others and will put their donations to good use. The organization, in turn, can rely on its members to meet their obligations to maintain their death benefits and therefore the organization can more accurately plan its activities based on standard mortality tables and like references. All in all, a practice of the program of the invention presents a win/win situation for both the organization and its individual members.

While my invention has been shown and described herein in terms of a certain preferred embodiment, it should be understood that other embodiments as should be apparent to those of ordinary skill in the art are also within the scope of this invention. Accordingly, the scope of the invention should be understood to be defined only by the claims that follow, and a reasonable equivalency thereof, which claims I regard as my invention.

1. A charitable organization funding a member benefit program comprising, a charitable organization that is qualified to receive tax deductive donations of money, goods and services and distributes human blood and blood products throughout the world; members of said charitable organization; a plan administered by said charitable organization whereby, for the member regularly paying dues to said charitable organization and regularly donating blood to said charitable organization, said charitable organization will provide and fully pay for, through a funeral plan that is funded from a minimum to maximum value as determined by said member's actual donations of money, goods and/or services, including blood, said member's funeral, and burial or cremation at their demise; and a computer for maintaining a record of individual member's contributions of money and blood to said charitable organization during said member's life for establishing said funeral plan value, taking into account a value of said donations and amount of money as have been donated, at said member's death.

2. The charitable organization funding and member benefit program of claim 1, further including, as an additional member contribution, said member agrees to donate their usable organs to the charitable organization upon their death; with the means for maintaining a record of individual member's contributions to further provide for tracking said member and coordinating with a medical entity, as said member designates, for the timely harvesting of said member's viable organs at their death; and which agreement to donate organs is considered in establishing the funeral plan value

3. The charitable organization funding and member benefit program of claim 2, wherein, the computer for maintaining a record contains the member's personal information includes said member's social security number, blood type, DNA information, and data for facilitating coordinating the harvesting and utilization of said member's usable organs at their death.

4. The charitable organization funding and member benefit program of claim 1, further including, as member benefits, discounts on products and services, and legal services as relate to estate planning matters.

5. The charitable organization funding and member benefit program of claim 1, further including, to the extent of the actuarial value of the member's blood donations, the charitable organization purchases a life insurance policy on said member, payable to said charitable organization, to fund cost of said member's funeral and burial or cremation.

6. The charitable organization funding and member benefit program of claim 1, wherein, the charitable organization establishes the value of said funeral and burial or cremation by said member's donations to said charitable organization, and said funeral plan value can be increased by payments from the deceased member's family, as they determine and at the expense of said deceased member's family.
